(19) United States
(12) Patent Application Publication
(10) Pub. No.: US 2013/0114243 A1
(43) Pub. Date: May 9, 2013

(54) CEILING FIXTURE

(71) Applicants: Mu-Tao Chu, Hsinchu City (TW); Hung-Lieh Hu, Hsinchu City (TW); Chao-Wei Li, Hsinchu City (TW); Hsin-Hsiang Lo, Hsinchu County (TW); Chen-Kun Chen, Changhua County (TW)

(72) Inventors: Mu-Tao Chu, Hsinchu City (TW); Hung-Lieh Hu, Hsinchu City (TW); Chao-Wei Li, Hsinchu City (TW); Hsin-Hsiang Lo, Hsinchu County (TW); Chen-Kun Chen, Changhua County (TW)

(73) Assignee: INDUSTRIAL TECHNOLOGY RESEARCH INSTITUTE, Hsinchu (TW)

(21) Appl. No.: 13/410,300

(22) Filed: Mar. 2, 2012

Related U.S. Application Data
(60) Provisional application No. 61/557,352, filed on Nov. 8, 2011.

(30) Foreign Application Priority Data
Mar. 1, 2012 (TW) 101106747

(51) Int. Cl. F21S 8/04; F21V 9/16; F21V 15/01; F21V 29/00; F21V 11/00

(52) U.S. Cl. 362/84; 362/382; 362/249.02; 362/235; 362/363; 362/249.06

(57) ABSTRACT

A ceiling fixture including a first heat dissipation structure, a circuit board and a flexible light source is provided. The first heat dissipation structure has a curved surface, a containing cavity and a plurality of heat dissipation channels. Each heat dissipation channel is connected to the containing cavity and the external environment. The circuit board is disposed in the containing cavity and contacts the first heat dissipation structure. The flexible light source is disposed on the curved surface.

### CROSS-REFERENCE TO RELATED APPLICATION

This application claims the priority benefit of U.S. provisional application Ser. No. 61/557,352, filed on Nov. 8, 2011 and Taiwan application serial no. 101106747, filed on Mar. 1, 2012. The entirety of each of the above-mentioned patent applications is hereby incorporated by reference herein and made a part of specification.

### TECHNICAL FIELD

The technical field relates to a ceiling fixture.

### BACKGROUND

A light emitting diode (LED) is a semiconductor element, and the material for forming a light emitting chip using the LED mainly includes group III-V chemical compounds, such as gallium phosphide (GaP), gallium arsenide (GaAs), and other compound semiconductors. Using the light emitting principle of the semiconductor PN junction, electric energy is converted into light. In detail, an LED applies electric current to a compound semiconductor, so that redundant energy is released in the form of light through the combination of electrons and electron holes, thereby achieving the light emitting effect. Since the luminance of the LED is not caused by thermal emission or electric discharge but by cold luminance, the life span of the LED may be more than 100,000 hours. The LED has the advantage of quick response speed, compact size, low power consumption, low pollution, high reliability and also easy adaptation for mass production. The applications of the LED are extensive, for example light sources of mega-size outdoor display boards, traffic lights, cell phones, fax machines and ceiling fixtures.

A ceiling fixture generally includes a housing, a circuit board and a plurality of light emitting diodes as the light source. The circuit board and the LED light sources are disposed on the housing. The housing is fixed to the ceiling and the LED light sources are adapted to emit light for illumination. With the disposition described above, the heat generated by the LED light sources and the circuit board is dissipated through the housing to the ceiling. However, the heat conductivity of the ceiling is unfavorable and affects the heat conductivity of the ceiling fixture. Moreover, to obtain a superior light emitting angle of the ceiling fixture, a lampshade is disposed covering the LED light sources, the profile of which adjusts the light emitting angle of the LED light sources, which increases the production cost.

### SUMMARY

A ceiling fixture including a first heat dissipation structure, a circuit board and a flexible light source is provided. The first heat dissipation structure has a curved surface, a containing cavity and a plurality of heat dissipation channels. Each heat dissipation channel is connected to the containing cavity and the external environment. The circuit board is disposed in the containing cavity and contacts the first heat dissipation structure. The flexible light source is disposed on the curved surface. The heat generated by the circuit board and the flexible light source is dissipated by the heat dissipation channels.

### BRIEF DESCRIPTION OF THE DRAWINGS

FIG. 1 is a schematic view of a ceiling fixture according to an embodiment.

FIG. 2 is a locally enlarged view of the ceiling fixture of FIG. 1.

FIG. 3 is a bottom view of the flexible light source of FIG. 2.

FIG. 4 is a bottom view of a flexible light sources according to another embodiment.

FIG. 5 is a local enlarged view of a ceiling fixture according to another embodiment.

FIG. 6 is a local schematic view of a first heat dissipation structure according to another embodiment.

FIG. 7 is a schematic view of a ceiling fixture according to another embodiment.

Common reference numerals are used throughout the drawings and the detailed description to indicate the same elements. The present invention will be more apparent from the following detailed description taken in conjunction with the accompanying drawings.

### DESCRIPTION OF EMBODIMENTS

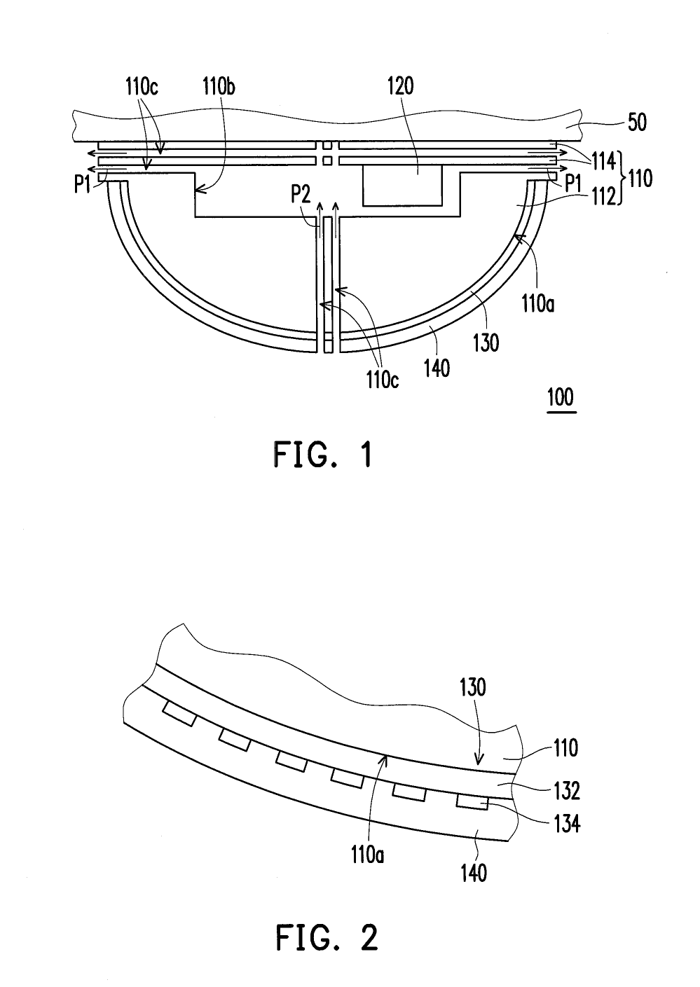

FIG. 1 is a schematic view of a ceiling fixture according to an embodiment. Referring to FIG. 1, the ceiling fixture 100 of the present embodiment includes a first heat dissipation structure 110, a circuit board 120 and a flexible light source 130. The first heat dissipation structure 110 is fixed to the fixed end 50, for example, a ceiling of a building, and has a curved surface 110a, a containing cavity 110b and a plurality of heat dissipation channels 110c. Each heat dissipation channel 110c is connected to the containing cavity 110b and the external environment. The circuit board 120 is disposed in the containing cavity 110b and contacts the first heat dissipation structure 110. The flexible light source 130 is disposed on the curved surface 110a of the first heat dissipation structure 110. The circuit board 120 is configured to drive the flexible light source 130 to emit light for illumination.

With the disposition described above, the flexibility of the flexible light source 130 enables the flexible light source 130 to attach closely to the curved surface 110a, and the curved surface 110a, such as a convex surface, allows the flexible light source 130 to have a wider light emitting angle. In another embodiment, the first heat dissipation structure 110 could have another form of curved surface to adjust the light emitting angle of the flexible light source 130.

The heat dissipation channels 110c increase the heat dissipation area of the first heat dissipation structure 110. The heat generated by the circuit board 120 and the flexible light source 130 can be dissipated by the heat dissipation channels 110c. When the heat generated by the flexible light source 130 and the circuit board 120 during operation transmits to the first heat dissipation structure 110, the first heat dissipation structure 110 guides the heat to the external environment by the convection of the air in the heat dissipation channels 110c.

For example, when the hot air in the containing cavity 110b flows to the external environment along a direction P1, the pressure in the containing cavity 110b is reduced so as to drive the air in the heat dissipation channels 110c flowing into the containing cavity 110b along a direction P2 flowing to the external environment along the direction P1, thus air convection is formed which is conducive to the heat dissipation. The location and the extending direction of the heat dissipation channels 110c are not limited in the present embodiment, and neither is the direction of the air convection caused by the heat dissipation channels 110c. In other embodiments, the heat dissipation channels 110 can adopt other suitable designs so as to form air convection in other directions.

The first heat dissipation structure 110 of the present embodiment includes a first heat dissipation member 112 and a second heat dissipation member 114. The curved surface 110a and the containing cavity 110b are formed on the first heat dissipation member 112. The second heat dissipation member 114 is fixed to the first heat dissipation member 112 and covers the containing cavity 110b. The circuit board 120 contacts the second heat dissipation member 114 so as to transmit the heat to the first heat dissipation structure 110, but the disclosure is not limited thereto. In other embodiments, the circuit board 120 also can contact the first heat dissipation member 112 instead of contacting the second heat dissipation member 114.

As shown in FIG. 1, in an embodiment a gap is formed between the first heat dissipation member 112 and the second heat dissipation member 114 so as to form the heat dissipation channels 110c between the first heat dissipation member 112 and the second heat dissipation member 114. The other heat dissipation channels 110c are respectively formed on the first heat dissipation member 112 and the second heat dissipation member 114. The heat dissipation channels 110c formed on the first heat dissipation member 112 further penetrate the flexible light source 130 which is conducive to the circulation of the heat dissipation air flow.

FIG. 2 is a locally enlarged view of the ceiling fixture of FIG. 1. Referring to FIG. 2, the flexible light source 130 includes a flexible circuit board 132 and a plurality of light emitting diode (LED) light sources 134. The flexible circuit board 132 is disposed on the first heat dissipation structure 110. The LED light sources 134 are disposed on the flexible circuit board 132 by chip on board (COB), surface mounted technology (SMT) or other suitable methods. Due to the flexibility of the flexible circuit board 132 and the curved surface 110a of the first heat dissipation structure 110, the LED light sources 134 can have superior light emitting angles. The LED light sources 134 described above are, for example, face up type LED chips, flip-chip type LED chips, vertical type LED chips or other suitable type LED chips, and the disclosure is not limited thereto.

In the present embodiment, the LED light sources 134 can be short wavelength LED light sources such as blue LEDs or ultraviolet light (UV) LEDs. The ceiling fixture 100 can further includes a transparent housing 140. The transparent housing 140 covers the flexible light source 130 for protecting the flexible light source 130 and further improving the mechanical strength of the whole structure. In detail, wavelength converting material, for example, phosphor, can be coated on the transparent housing 140 to change the color of the light emitted by the LED light sources 134. For example, the LED light sources 134 are blue LEDs and the phosphor on the transparent housing 140 is yellow phosphor. After the blue light emitted by the LED light sources 134 passes the transparent housing 140 with yellow phosphor, part of the blue light converts to yellow light and part of the blue light directly penetrates the transparent housing 140, so as to generate white light by mixing the blue light and the yellow light. The ceiling fixture 100 thus can perform illumination with the white light. The transparent housing 140 can also not be coated with phosphor and the LED light sources 134 can be white LEDs, so the ceiling fixture can still perform illumination with white light.

In other embodiments, the ceiling fixture 100 can further utilize the other colors of phosphor incorporated with LED light sources of other types to generate various illuminating light, and the disclosure is not limited thereto. Taking generating white illuminating light for example, the LED light sources 134 can be blue LEDs and the phosphor on the transparent housing 140 can include green phosphor and red phosphor. After the blue light emitted by the LED light sources 134 passes the transparent housing 140 with green phosphor and red phosphor, part of the blue light converts to green light and red light and part of the blue light directly penetrates the transparent housing 140, so as to generate white light by mixing green, red and blue light. The ceiling fixture 100 thus can perform illumination with white light. Moreover, the LED light sources 134 can be UV LEDs and the phosphor on the transparent housing 140 can include yellow phosphor, blue phosphor and green phosphor. After the UV light emitted by the LED light sources 134 passes the transparent housing 140 with yellow phosphor, blue phosphor and green phosphor, at least part of the UV light converts to green, red and blue light, so as to generate white light by mixing the green, red and blue light. The ceiling fixture 100 thus can perform illumination with white light. Furthermore, the transparent housing 140 can also not be disposed on the ceiling fixture 100 so as to expose the flexible light source 130, and the disclosure is not limited thereto.

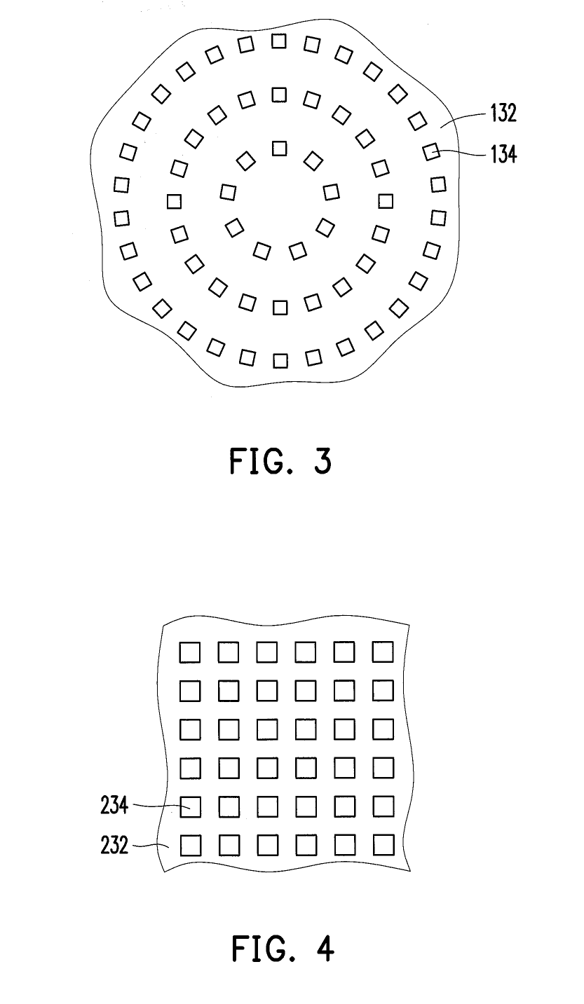

FIG. 3 is a bottom view of the flexible light source of FIG. 2. Referring to FIG. 3, in an embodiment, the LED light sources 134 are, for example, arranged in a pattern of a plurality of concentric circles. FIG. 4 is a bottom view of a flexible light source according to another embodiment. Referring to FIG. 4, in an embodiment, the LED light sources 234 are, for example, arranged in an array on the flexible circuit board 232. The arrangement of the LED light sources is not limited in the disclosure, and in other embodiments, the LED light sources can be arranged in other suitable ways.

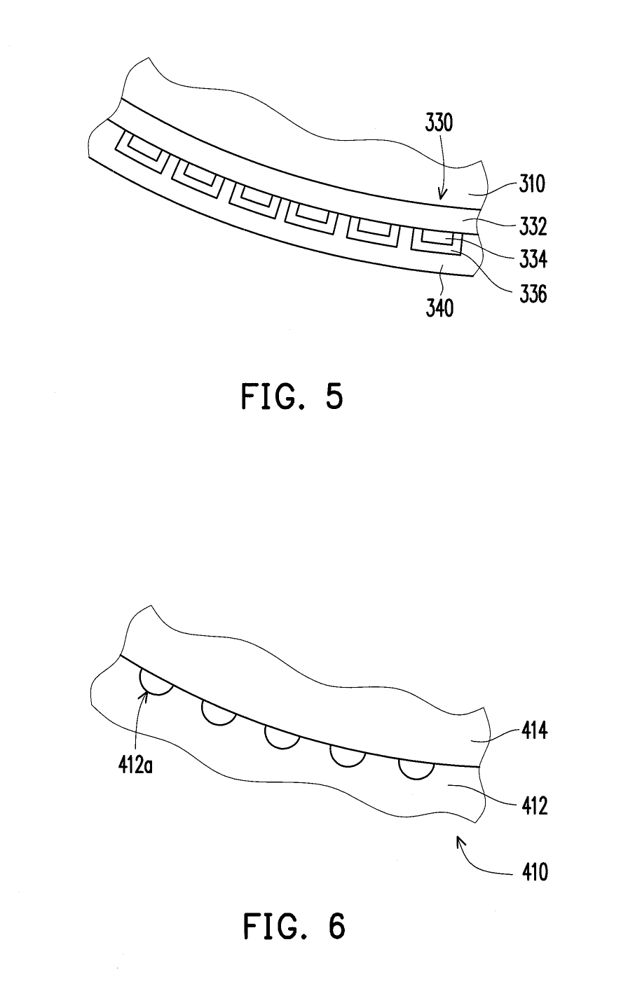

FIG. 5 is a local enlarged view of a ceiling fixture according to another embodiment. Referring to FIG. 5, the disposition of the first heat dissipation structure 310, the flexible circuit board 332, the LED light sources 334 and the transparent housing 340 are similar to the disposition of the first heat dissipation structure 110, the flexible circuit board 132, the LED light sources 134 and the transparent housing 140 in FIG. 2, and will not be described in detail herein. The difference between the embodiment shown in FIG. 5 and the embodiment shown in FIG. 2 is that the flexible light source 330 further includes a plurality of optical elements 336. The optical elements 336 are disposed on the flexible circuit board 332 and respectively cover the LED light sources 332 so as to further improve the light emitting quality of the LED light sources 332. For example, the optical element 336 can include light diffusion elements such that the light emission of the LED light sources 332 can be more uniform.

FIG. 6 is a local schematic view of a first heat dissipation structure according to another embodiment. Referring to FIG. 6, the first heat dissipation structure 410 includes a first heat dissipation member 412 and a second heat dissipation member 414. The first heat dissipation member is assembled to the second heat dissipation member 414. The first heat dissipation member includes a plurality of trenches 412a. The trenches 412a are covered by the second heat dissipation member 414 so as to form a plurality of heat dissipation channels similar to the heat dissipation channels 110c in FIG. 1. In the design shown in FIG. 6, the trenches 412a can be firstly formed on the first heat dissipation member 412 and then the second heat dissipation member 414 is assembled to the first heat dissipation member 412 and covers the trenches 412a to form the heat dissipation channels. Thus, there is no need to form the heat dissipation channels penetrating the first heat dissipation member 412 or the second heat dissipation member 414 such that the difficulty in fabricating process is reduced.

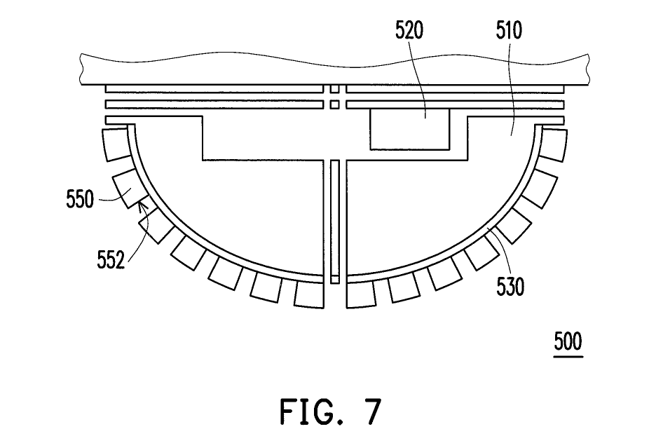

FIG. 7 is a schematic view of a ceiling fixture according to another embodiment. In the ceiling fixture 500 of an embodiment, the disposition of the first heat dissipation structure 510, the circuit board 520 and the flexible light source 530 is similar to the disposition of the first heat dissipation structure 110, the circuit board 120 and the flexible light source 130 in FIG. 1, and will not be described herein. The differences between the ceiling fixture 500 and the ceiling fixture 100 are that the ceiling fixture 500 further includes a second heat dissipation structure 550. The second heat dissipation structure 550 is disposed on the flexible light source 530 and has a plurality of openings 552. The openings 552 expose at least part of the LED light sources of the flexible light source 530. The disposition of the second heat dissipation structure 550 and the openings thereof can further increase the heat dissipation area so as to enhance the heat dissipation efficiency.

The material of the second heat dissipation structure 550 can be transparent material, and also can be metal or other non-transparent material. When the material of the second heat dissipation structure 550 is transparent material, the circuit board 520 can control the LED light sources to emit light, wherein the LED light sources are covered by the second heat dissipation structure 550, such that the emitted light can have a condensing effect, or the circuit board 520 can control the LED light sources to emit light, wherein the LED light sources are exposed by the openings 552, such that the emitted light can be uniform. When the material of the second heat dissipation structure 550 is metal or other non-transparent material, the LED light sources exposed by the openings 552 emit the light, and the emitted light is reflected by the second heat dissipation structure 550 so as to change the profile of the light emitted by the ceiling fixture 500.

The LED light sources of the flexible light source 530 can be white light with different color temperature, such that color of the light is changeable. Furthermore, the LED light sources of the flexible light source 530 can be different or can be the same single-colored light for situational lighting.

In sum, in the ceiling fixture of the disclosure, the flexible light source is disposed on the curved surface of the first heat dissipation structure and the first heat dissipation structure has a plurality of heat dissipation channels. The flexible light source can be attached closely to the curved surface due to the flexibility of the flexible light source such that the flexible light source has a superior light emitting angle. Moreover, the heat dissipation channels increase the heat dissipation area of the first heat dissipation structure, and when the heat generated by the flexible light source and the circuit board during operation transmits to the first heat dissipation structure, the first heat dissipation structure guides the heat to the external environment by the convection of the air in the heat dissipation paths so as to improve the heat dissipation efficiency. Furthermore, a plurality of optical elements such as light diffusion elements can be further disposed on the LED light sources of the flexible light source to further enhance the light emitting quality of the flexible light source.

While the invention has been described and illustrated with reference to specific embodiments thereof, these descriptions and illustrations do not limit the invention. It should be understood by those skilled in the art that various changes may be made and equivalents may be substituted without departing from the true spirit and scope of the invention as defined by the appended claims. The illustrations may not necessarily be drawn to scale. There may be distinctions between the artistic renditions in the present disclosure and the actual apparatus due to manufacturing processes and tolerances. There may be other embodiments of the present invention which are not specifically illustrated. The specification and the drawings are to be regarded as illustrative rather than restrictive. Modifications may be made to adapt a particular situation, material, composition of matter, method, or process to the objective, spirit and scope of the invention. All such modifications are intended to be within the scope of the claims appended hereto. While the methods disclosed herein have been described with reference to particular operations performed in a particular order, it will be understood that these operations may be combined, sub-divided, or re-ordered to form an equivalent method without departing from the teachings of the invention. Accordingly, unless specifically indicated herein, the order and grouping of the operations are not limitations of the invention.

What is claimed is:

1. A ceiling fixture, comprising:
a first heat dissipation structure, having a curved surface, a containing cavity and a plurality of heat dissipation channels, wherein each heat dissipation channel is connected to the containing cavity and the external environment;
a circuit board, disposed in the containing cavity and contacting the first heat dissipation structure; and
a flexible light source, disposed on the curved surface, wherein heat generated by the circuit board and the flexible light source is dissipated by the heat dissipation channels.

2. The ceiling fixture as claimed in claim 1, wherein the first heat dissipation structure comprises a first heat dissipation member and a second heat dissipation member, the curved surface and the containing cavity are formed on the first heat dissipation member, and the second heat dissipation member is fixed to the first heat dissipation member and covers the containing cavity.

3. The ceiling fixture as claimed in claim 1, wherein the first heat dissipation structure comprises a first heat dissipation member and a second heat dissipation member, the first heat dissipation member is assembled to the second heat dissipation member, and a part of the heat dissipation channels are formed between the first heat dissipation member and the second heat dissipation member.

4. The ceiling fixture as claimed in claim 3, wherein the first heat dissipation member has a plurality of trenches, and the trenches are covered by the second heat dissipation member so as to form part of the heat dissipation channels.

5. The ceiling fixture as claimed in claim 1, wherein part of the heat dissipation channels penetrate through the flexible light source.

6. The ceiling fixture as claimed in claim 1, wherein the flexible light source comprises a flexible printed circuit board and a plurality of light emitting diode (LED) light sources, the flexible printed circuit board is disposed on the first heat dissipation structure and the LED light sources are disposed on the flexible printed circuit board.

7. The ceiling fixture as claimed in claim 6, further comprising a second heat dissipation structure, disposed on the flexible light source and having a plurality of openings, wherein the openings expose at least part of the LED light sources.

8. The ceiling fixture as claimed in claim 7, wherein the material of the second heat dissipation structure comprises transparent material.

9. The ceiling fixture as claimed in claim 6, wherein the flexible light source further comprises a plurality of optical elements, disposed on the flexible printed circuit board and covering the LED light sources respectively.

10. The ceiling fixture as claimed in claim 9, wherein the optical elements comprise light diffusion elements.

11. The ceiling fixture as claimed in claim 6, wherein the LED light sources are arranged in array or in a pattern of a plurality of concentric circles.

12. The ceiling fixture as claimed in claim 1, further comprising a transparent housing, covering the flexible light source.

13. The ceiling fixture as claimed in claim 12, wherein the material of the transparent housing includes wavelength converting material.

14. The ceiling fixture as claimed in claim 13, wherein the flexible light source comprises a plurality of blue LEDs, and the wavelength converting material is yellow phosphor.

15. The ceiling fixture as claimed in claim 1, wherein the curved surface is a convex surface.
